(19) United States
(12) Patent Application Publication
(10) Pub. No.: US 2003/0216673 A1
(43) Pub. Date: Nov. 20, 2003

(54) Massaging machine

(75) Inventors: Akitoshi Miki, Ibaraki (JP); Kentaro Mori, Nara (JP)

Correspondence Address: BEYER WEAVER & THOMAS LLP, P.O. BOX 778, BERKELEY, CA, 94704-0778, US

(73) Assignee: OMRON Corporation

(21) Appl. No.: 10/437,499

(22) Filed: May 13, 2003

(30) Foreign Application Priority Data
May 14, 2002 (JP) 2002-177759

(51) Int. Cl. A61H 15/00

(52) U.S. Cl. 601/99; 601/100; 601/102; 601/103; 601/116

(57) ABSTRACT

A massaging machine has massaging balls, ball supporting arms for supporting these massaging balls, a first rotary shaft and a second rotary shaft that have mutually parallel axes of rotation at different heights, an eccentric part on the first shaft that is eccentric with respect to its axis of rotation, a sloped part on the second shaft that is sloped with respect to its axis of rotation, a support arm with one end part attached to the ball supporting arm and the other end part attached to the sloped part, and a link that connects the eccentric part with the support arm. The support arm has a bearing with a spherical surface. The link has a spherically shaped end part that engages with the bearing. The ball supporting arms are attached to the support arm at a height between the heights of the first and second rotary shafts.

### BACKGROUND OF THE INVENTION

This invention relates to a massaging machine.

There have been known massaging machines of a type comprised of a movable treatment part with respect to the backrest part of a chair or a seat, the treatment part having two rotary shafts disposed parallel to each other, one of which having an eccentric part made eccentric with respect to its axis of rotation and the other of which having an eccentrically sloped part which is inclined with respect to its axis of rotation. Such a massaging machine is further provided with a link with one end rotatably attached to the eccentric part and a supporting arm attached rotatably to the sloped part, the other end part of the link and the supporting arm being connected by means of a bearing with a spherical surface and arm structures supporting massaging balls being attached to the support arm such that massaging and pounding operations can be effected as the rotary shafts are rotated.

Japanese Patent Publication Tokkai 2000-237257 has disclosed a massaging machine with a massaging part of this type, as shown in FIG. 24, having an arm structure 1403 attached to one end part of a supporting arm 1404 connected to an inclined part 1420, the other end part being connected to a link 1550 through a bearing 1407 with a spherical surface. The rotary shaft with the inclined part 1420 is disposed at a higher position than the other rotary shaft with an eccentric part 1521.

Japanese Patent Publication Tokkai 2001-238927 has also disclosed a massaging machine with a massaging part of a similar type, as shown in FIG. 25, having a support arm 2404 with one of its end parts attached to an inclined part 2420, an arm structure 2403 being attached to the other end part, and a link 2550 being attached through a bearing 2407 with a spherical surface at a position between where the inclined part 2420 and the arm structure 2403 are provided. The rotary shaft with the inclined part 2420 is disposed at a higher position than the other rotary shaft with an eccentric part 2521.

These prior art massaging machines have the following problems.

With the massaging machine according to aforementioned Japanese Patent Publication Tokkai 2000-237257, since the rotary shaft with the inclined part 1420 is disposed at a higher position than the other rotary shaft with an eccentric part 1521, the positions of the rotary shaft with the eccentric part 1521 and the massaging balls 1402 become too high and an accordingly large space must be reserved for their movements. As a result, the massaging machine as a whole becomes bulky.

With the massaging machine according to aforementioned Japanese Patent Publication Tokkai 2001-238927, force F10 will act on each of the massaging balls due to the weight of the user when the massaging machine is being used and the support arm 2404 is pushed by force F20, resulting in a clockwise moment M10 around the rotary shaft of the inclined part 2420. Thus, the force on the link 2550 becomes a tensile force and the support arm 2404 is subjected to a force F30 tending to pull the spherical part 2551 away from the bearing 2407. The larger will be this force for a heavier user. In order to prevent such a situation, an extra constituent member may be required and this will adversely affect the production cost of the massaging machine. Moreover, the area of contact between the spherical part 2551 and the bearing 2407 becomes smaller and this increases the possibility of a damage to the parts. As shown in FIG. 26, furthermore, the space required for the massaging balls and other parts which move along the backrest part 10a increases. This makes the backrest part 10a taller and the massaging machine 200 as a whole becomes bulky. If a control box 920 is placed at the bottom of the backrest part 10a, the massage machine 200 becomes even bulkier.

### SUMMARY OF THE INVENTION

It is therefore an object of this invention to provide a compact massaging machine.

A massaging machine embodying this invention may be characterized not only as comprising massaging balls, ball supporting arms for supporting them, at least two rotary shafts including a first shaft and a second shaft that have mutually parallel axes of rotation at different heights, an eccentric part on the first shaft that is eccentric with respect to its axis of rotation, a sloped part on the second shaft that is sloped with respect to its axis of rotation, a support arm with one end part attached to the ball supporting arm and the other end part attached to the sloped part, the support arm having a bearing with a spherical surface, and a link that connects the eccentric part with the support arm, the link having a spherically shaped end part that engages with the bearing, but also wherein the ball supporting arms are attached to the support arm at a height between the heights of the first shaft and the second shaft. With a massaging machine thus characterized, the structure including the massaging balls, their supporting arms, the rotary shafts that drive them as well as the support arm and the link that serve to communicate the rotary motions of the shafts for treatment operations can be contained within a relatively compact space such that the massaging machine as a whole can be made compact.

According to a preferred embodiment of the invention, the support arm is structured such that the bearing thereon is at an intermediate height between the heights at which the ball supporting arm and the sloped part are attached. With the support arm thus structured, the force from the support arm to the link is in the direction of pushing the spherical part when the weight of the user is acting on the massaging balls such that the spherically shaped end part of the link does not fall off the bearing and hence no extra component for preventing such a possibility is required and the production cost can be thereby reduced. Since the contact area between the spherical end part and the bearing surface is increased, the mechanical wears can be reduced.

### BRIEF DESCRIPTION OF THE DRAWINGS

FIG. 1 is a schematic front view of a massaging machine embodying this invention.

FIG. 2 is a schematic side view of the massaging machine of FIG. 1.

FIGS. 3A, 3B, 3C, 3D, 3E and 3F, together referred to as FIG. 3, are views of the vertically mobile treatment unit of the massaging machine of FIG. 1 from six mutually perpendicular directions.

FIG. 4 is a front view of the treatment unit of FIG. 3.

FIG. 5 is a back view of the treatment unit of FIG. 3.

FIG. 6 is a diagonal front view of the treatment unit of FIG. 3.

FIG. 7 is a diagonal back view of the treatment unit of FIG. 3.

FIG. 8 is a front view of the treatment part of the massaging machine of FIG. 1.

FIG. 9 is a left-hand side view of the treatment part of FIG. 8.

FIG. 10 is a back view of the treatment part of FIG. 8.

FIG. 11 is a right-hand side view of the treatment part of FIG. 8.

FIG. 12 is a diagonal front view of the treatment part of FIG. 8.

FIG. 13 is a diagonal right-hand back view of the treatment part of FIG. 8.

FIG. 14 is a diagonal sectional view of FIG. 13.

FIG. 15 is a diagonal left-hand back view of the treatment part of FIG. 8.

FIG. 16 is another diagonal sectional view of FIG. 13.

FIG. 17A shows the arm supporter for supporting massaging balls, FIG. 17B is its sectional view taken along line 17B-17B and FIG. 17C is another sectional view thereof taken along line 17C-17C.

FIGS. 18A and 18B, together referred to as FIG. 18, are schematic drawings for showing the improved effects of this invention compared to the prior art.

FIG. 19 is a schematic drawing for showing forces acting on various parts of the massaging machine of this invention.

FIG. 20 is a diagonal view of a lower part of the lifting mechanism of the massaging machine of FIG. 1.

FIG. 21 is a flowchart of basic operations of the massaging machine of FIG. 1.

FIG. 22 is a block diagram for the control system of the massaging machine of FIG. 1.

FIG. 23 is a drawing for showing the movements of the massaging balls.

FIG. 24 is a schematic drawing of a prior art example.

FIGS. 25A and 25B, together referred to as FIG. 25, are schematic drawings of another prior art example.

FIG. 26 is a schematic drawing for showing problem points with the second prior art example.

Throughout herein, components which are provided as a pair, one on the left-hand side and the other symmetrically on the right-hand side, are indicated by a same numeral and letters L and R may or may not be attached, depending on the convenience of disclosure and may not be described or explained individually, or both be shown in the drawings.

### DETAILED DESCRIPTION OF THE INVENTION

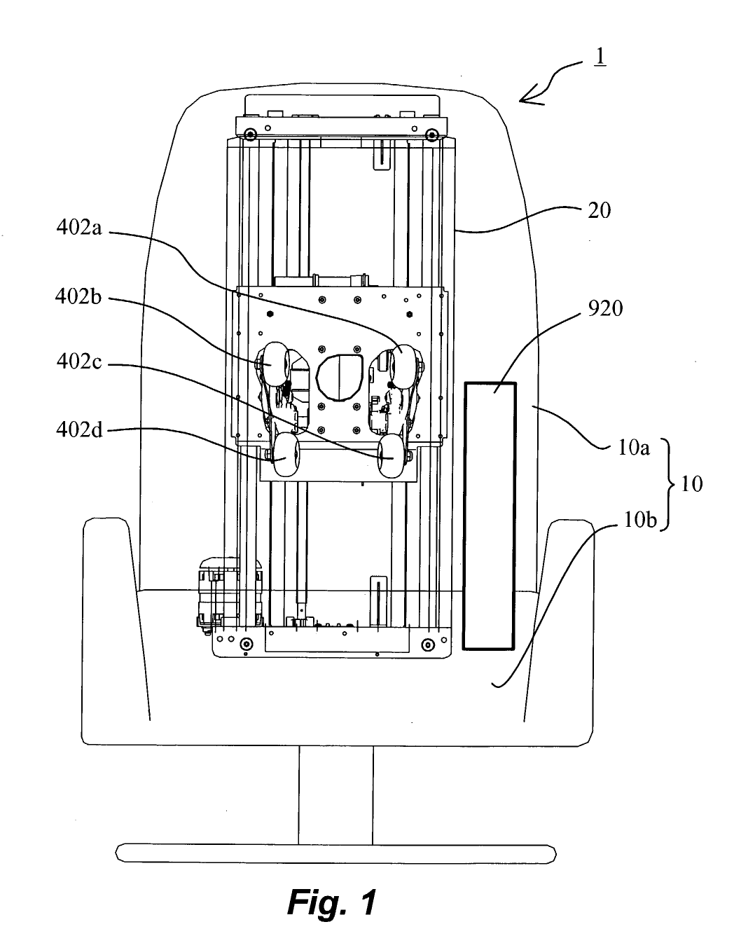

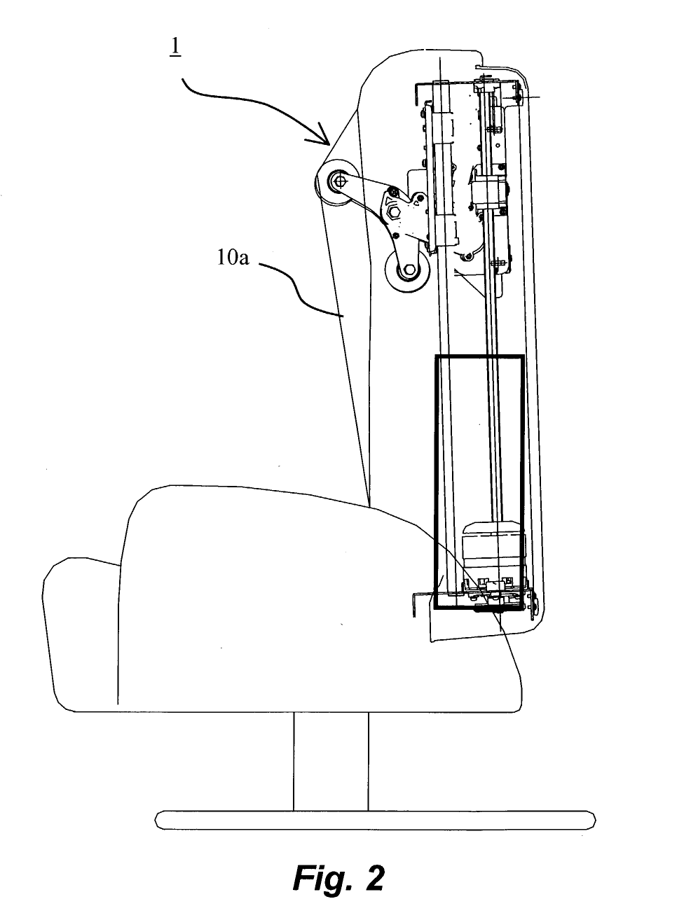

The invention is described by way of an example with reference to figures. FIG. 1 is a front view of a massaging machine 1 embodying this invention and FIG. 2 is its side view. The massaging machine 1, as shown, has a vertically mobile treatment unit 20 contained within a backrest portion 10a of its reclining chair structure 10. The backrest portion 10a is shown in FIGS. 1 and 2 by way of both its external contour and its internal structure. The body of a user is massaged by means of massaging balls 402a-d which protrude from the treatment unit 20 towards the front surface covered with a cover sheet for the backrest portion 10a. The massaging balls consist of an upper pair of left-hand side and right-hand side balls 402a and 402b and a lower pair of left-hand side and right-hand side balls 402c and 402d.

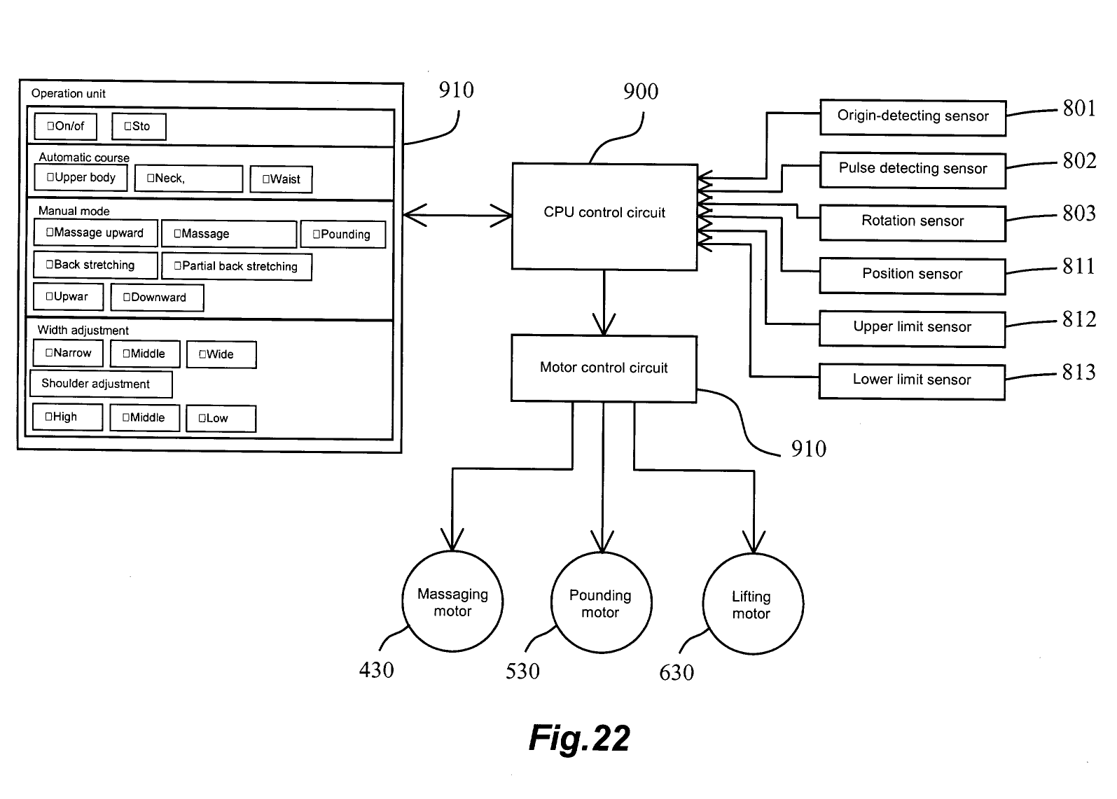

A control box 920 containing a CPU control circuit 900 for controlling the operations of the treatment unit 20 and a motor control circuit 901 (shown in FIG. 22) is disposed to one side of the treatment unit 20. The control box 920 is connected to a power source line (not shown) for supplying power from a home power source and an input device (shown in FIG. 22) for a user to operate for making an input operation.

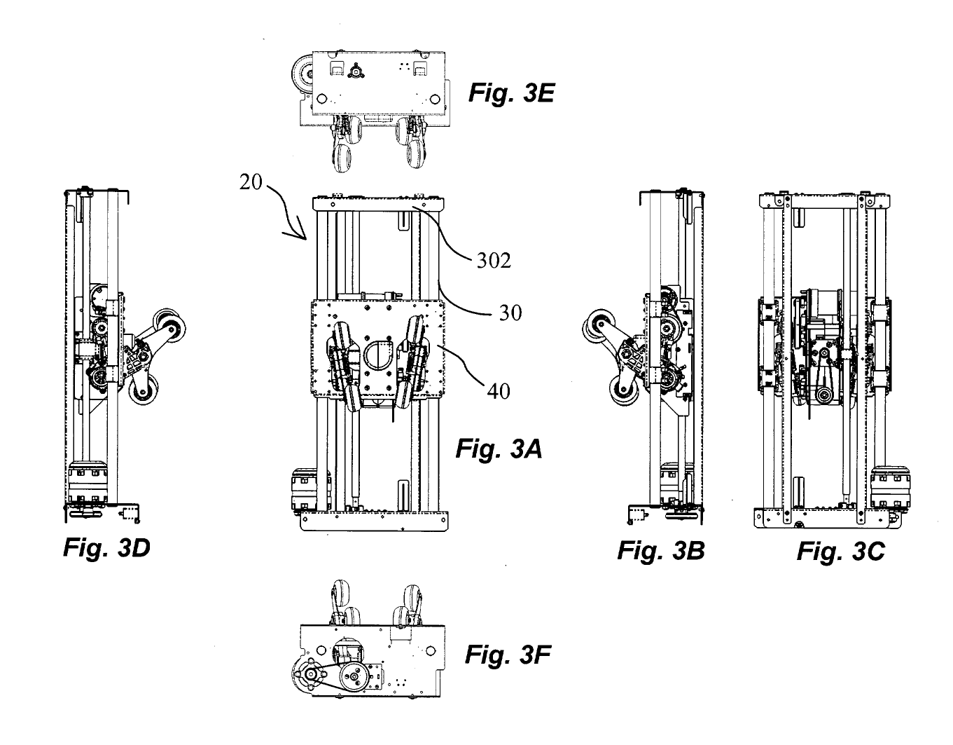

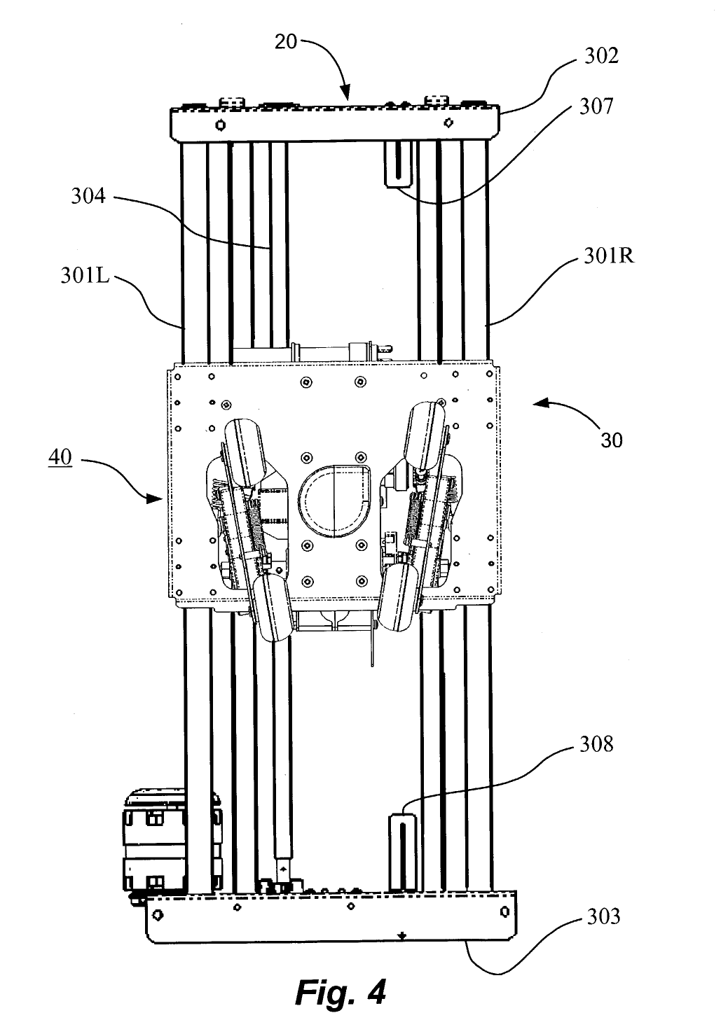

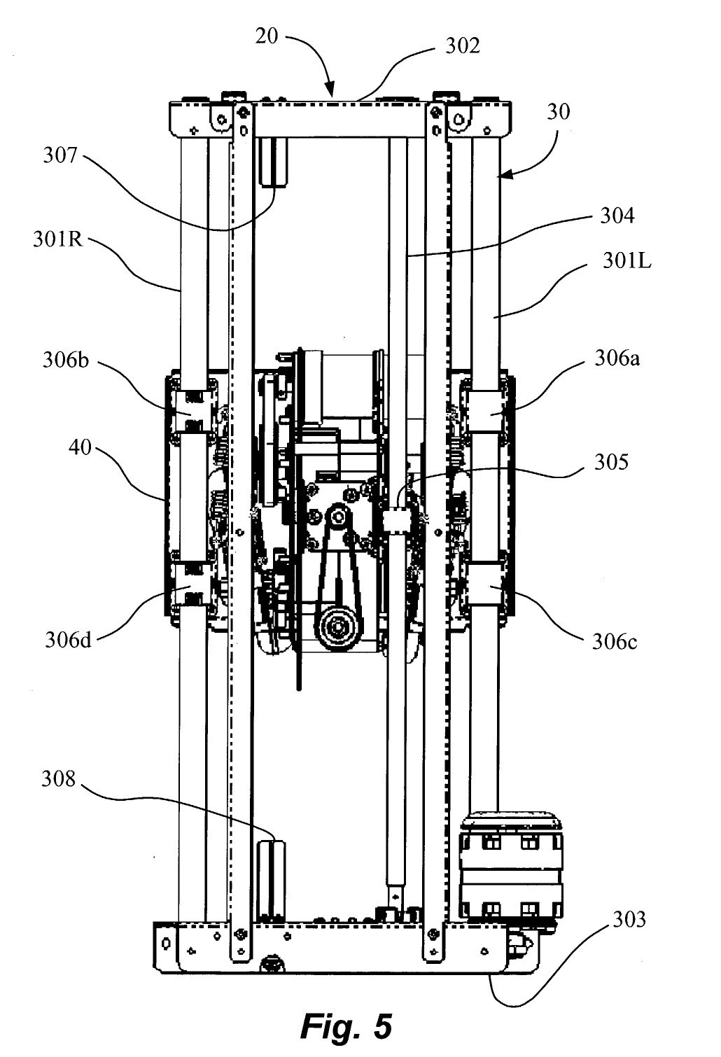

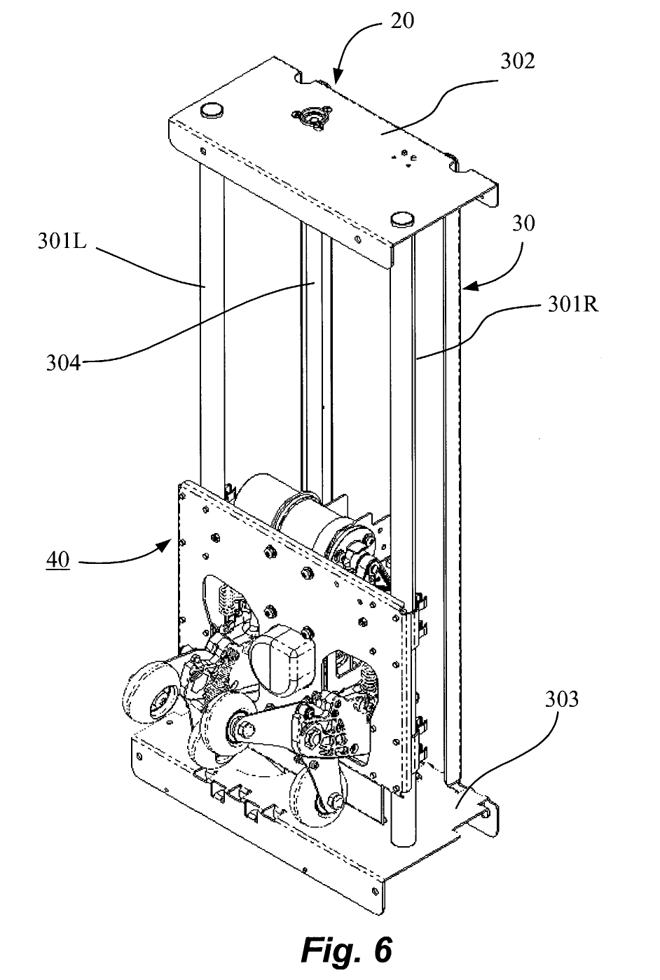

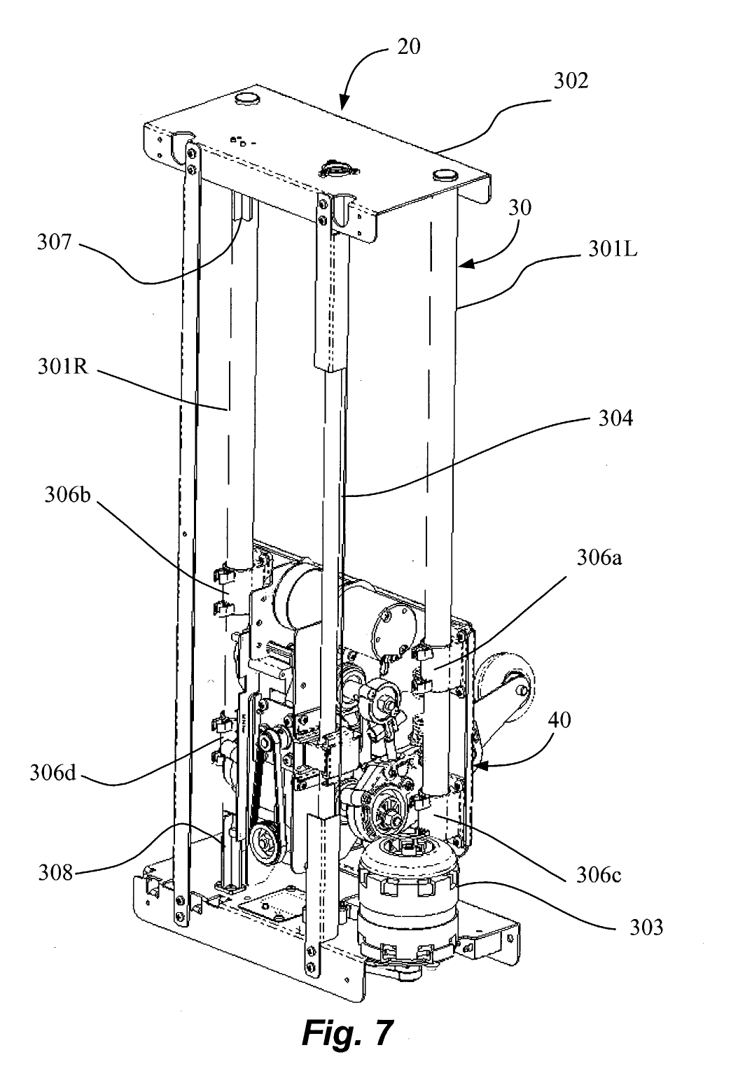

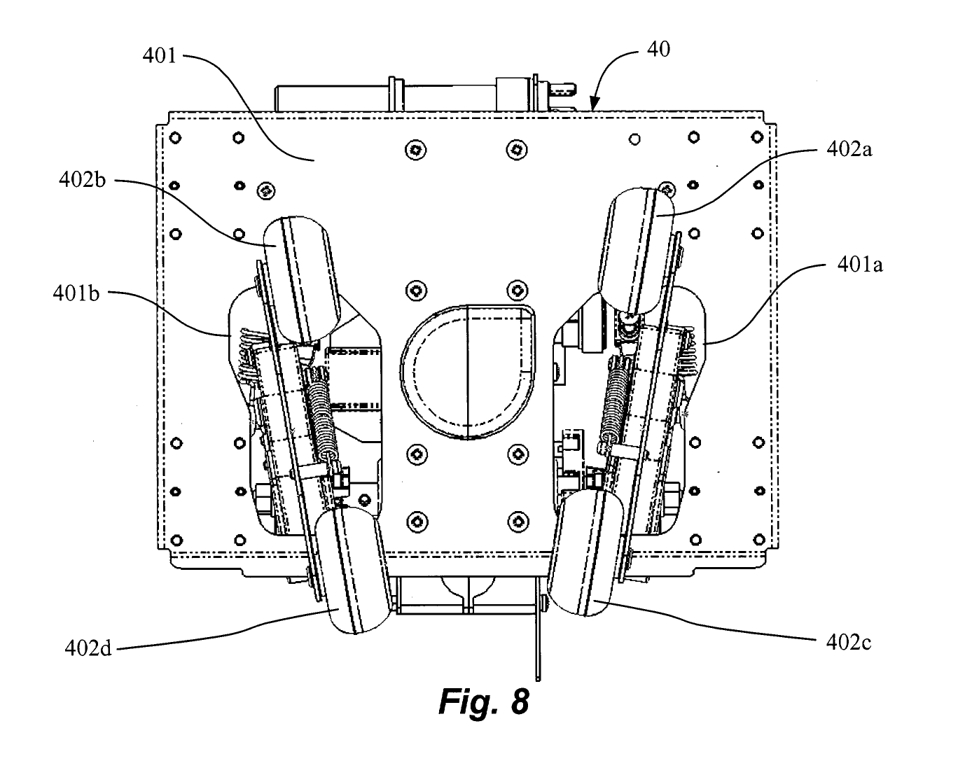

FIGS. 3A, 3B, 3C, 3D, 3E and 3F are respectively a front view, a right-hand side view, a back view, a left-hand side view, a plan view and a bottom view of the vertically mobile treatment unit 20. Its front view and back view are shown more in detail respectively in FIGS. 4 and 5. Its diagonal front view and diagonal back view are shown respectively in FIGS. 6 and 7.

In FIGS. 3-7, numeral 30 generally indicates a lifting mechanism that includes, as shown in FIGS. 4 and 6, a pair of guide pipes (“guiding members”) 301 (or 301R and 301L) which are circular in cross-section and disposed along the backrest portion 10a, a screw shaft 304 disposed between and parallel to the two guide pipes 301R and 301L, and a pair of upper and lower guide pipe holders 302 and 303 which extend perpendicularly to the guide pipes 301R and 301L. The guide pipes 301R and 301L are fixed to the guide pipe holders 302 and 303 but the screw shaft 304 is supported so as to be free to rotate.

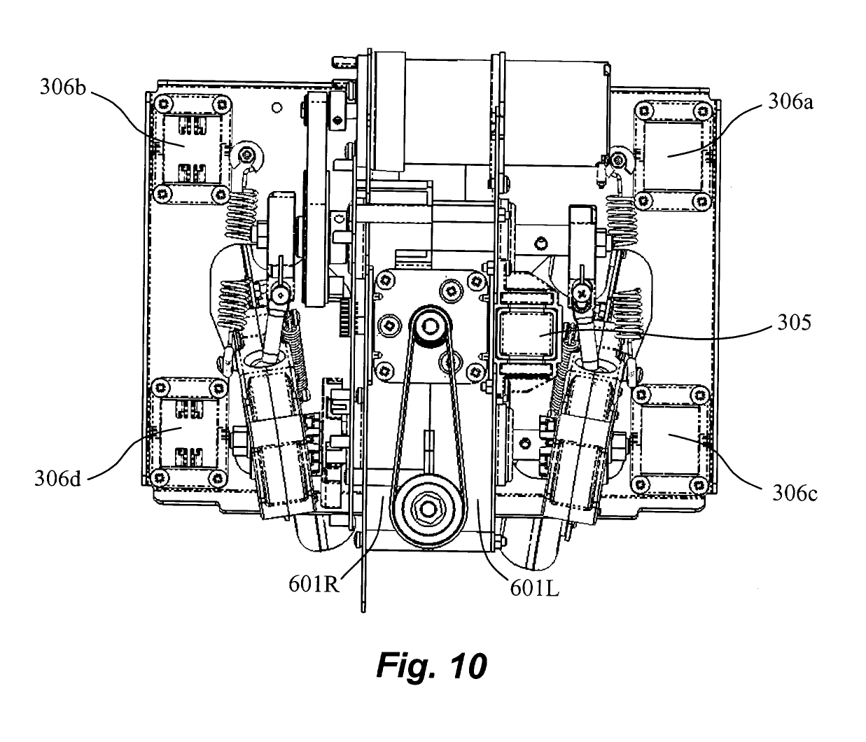

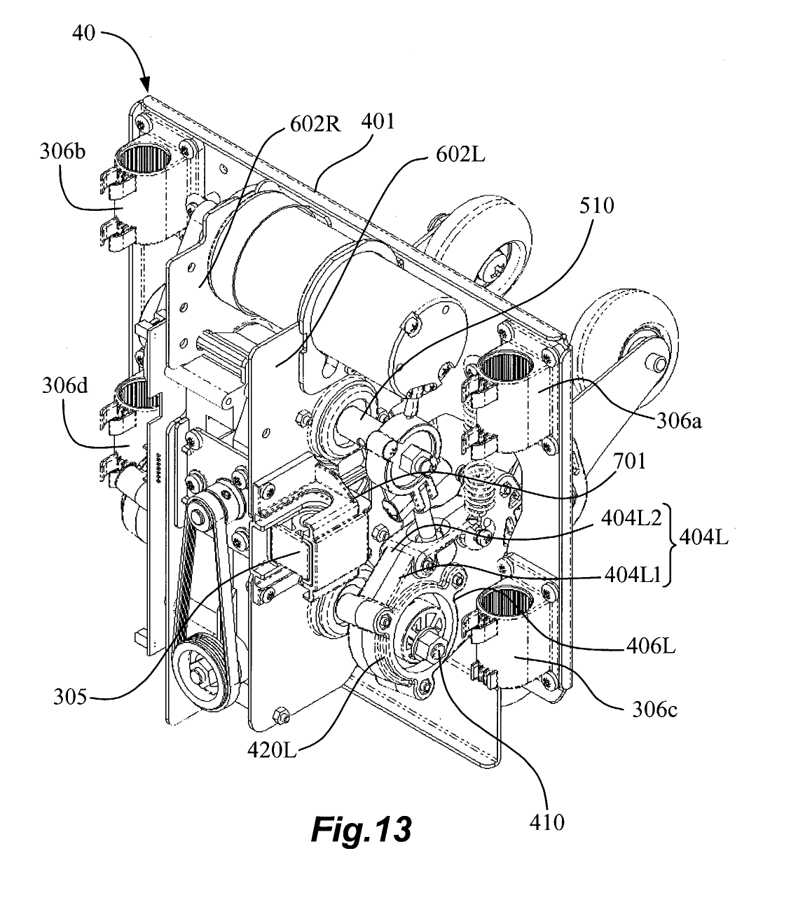

In FIG. 4 et seq., numeral 40 generally indicates a treatment part. As shown in FIGS. 5 and 7, the treatment part 40 is supported by the guide pipes 301R and 301L by means of lifting guides 306 (or 306a, 306b, 306c and 306d) which support it so as to be movable in their axial direction and a nut holder 701 for holding a nut 305 which engages the outer periphery of the screw shaft 304. See also FIGS. 10 and 13. As the screw shaft 304 is rotated and the nut 305 is accordingly pushed upward or downward, the nut holder 701 and the treatment part 40 that supports it move upward and downward along the guide pipes 301R and 301L.

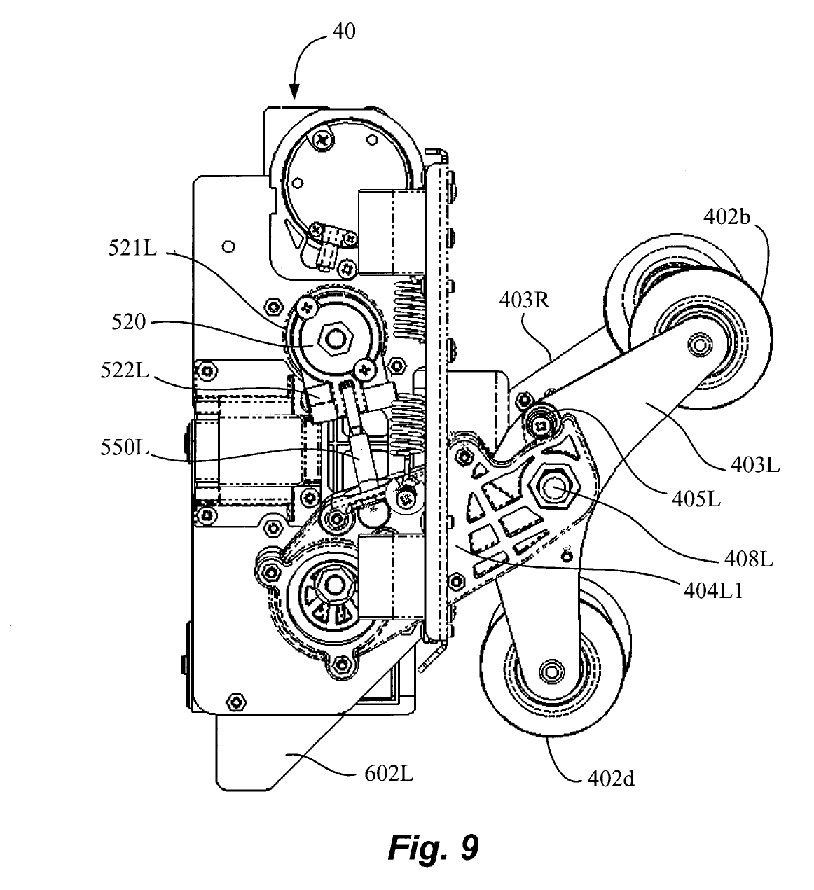

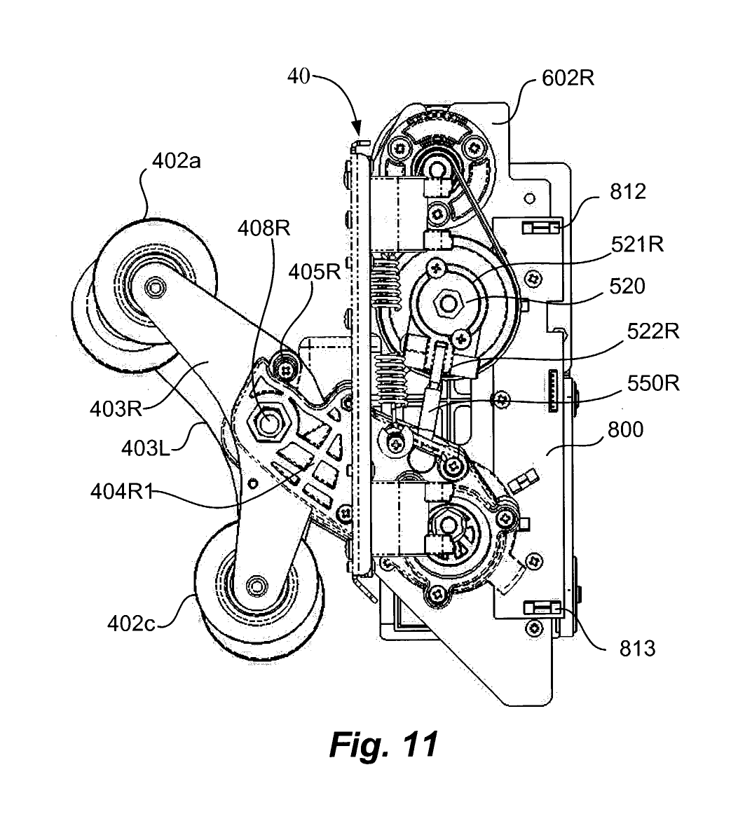

The treatment part 40 will be described next with reference to FIG. 8, et seq. The treatment part 40 has its front surface covered with a planar base member 401 provided with approximately rectangular openings 401a and 401b (FIG. 8) near its center for allowing the massaging balls 402a-d to penetrate therethrough. The four massaging balls 402a-d are supported rotatably at the tip parts of approximately V-shaped ball supporting arms (“ball supporting means”) 403R and 403L, as shown in FIGS. 9 and 11. The base end part of the right-hand side arm 403R is sandwiched between members 404R1 and 404R2 of an arm supporter 404R and supported rotatably by rotary shaft 408R, as shown in FIG. 11. The base end part of the left-hand side arm 403L is sandwiched between members 404L1 and 404L2 of arm supporter 404L and supported rotatably by rotary shaft 408L, as shown in FIGS. 9, 13 and 14. The supporting arms 403 (that is, 403R and 403L) are provided with stoppers 405 (or 405R and 405L) for stopping their rotary motion, as shown in FIGS. 9 and 11.

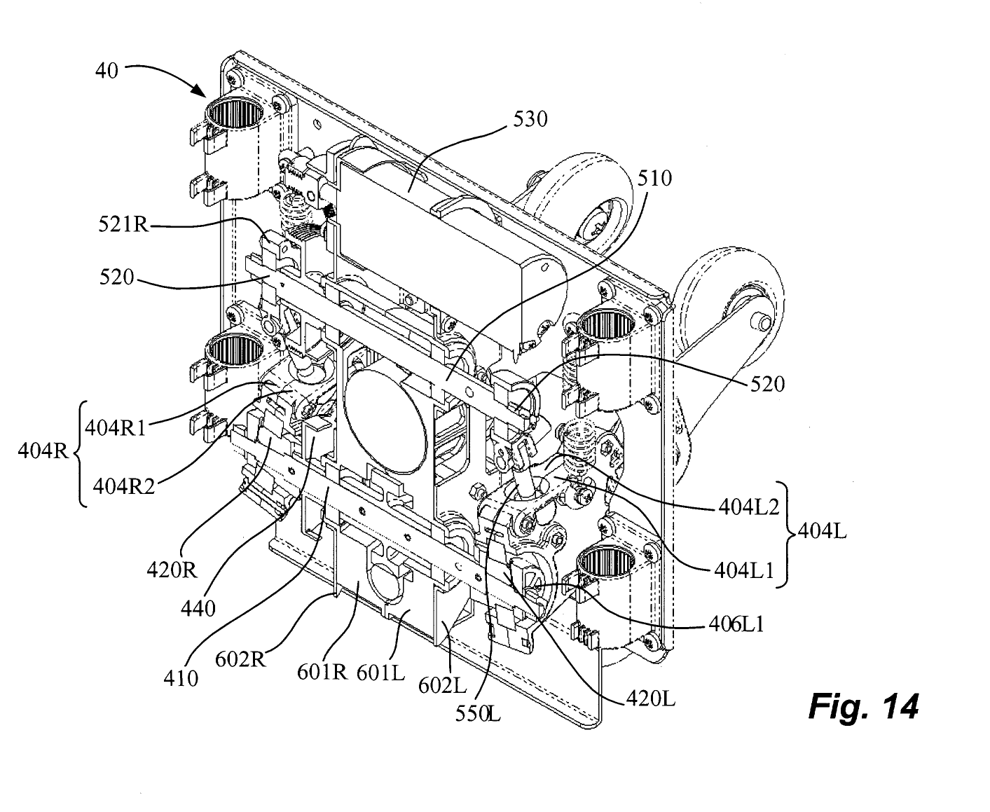

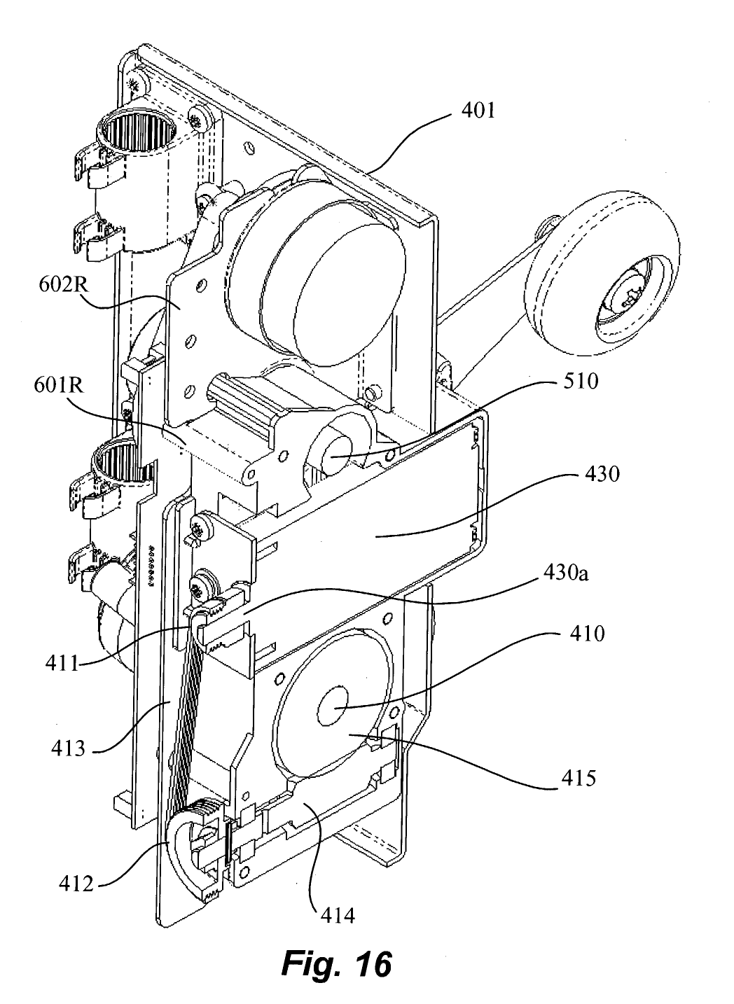

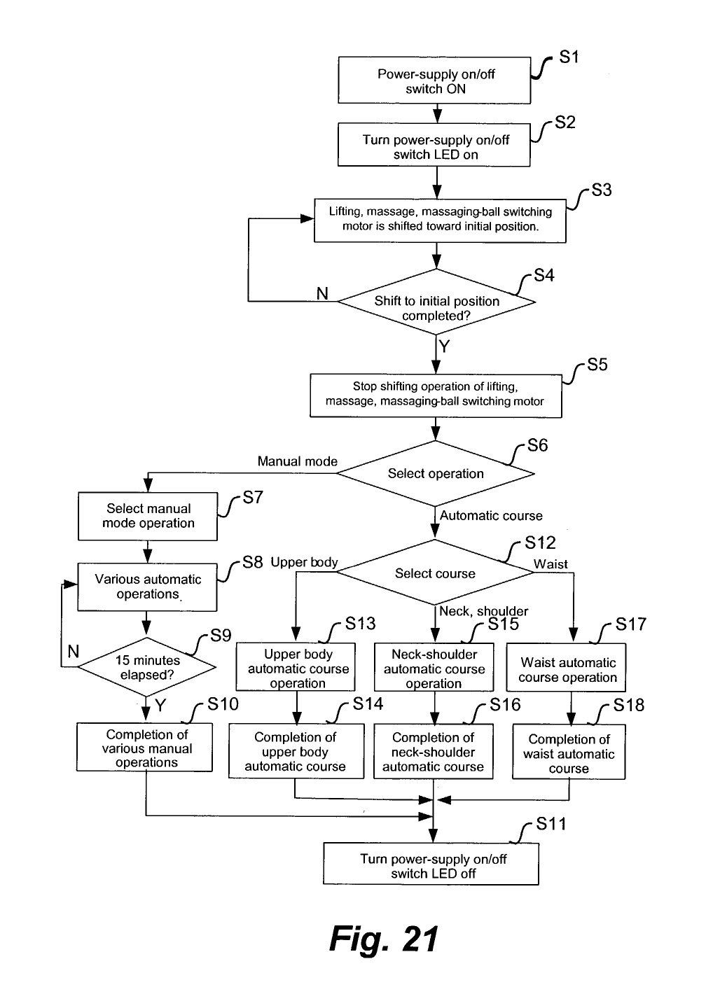

Numeral 410 in FIGS. 13 and 16 represents a rotary shaft for the massaging operation, herein referred to as the “massaging shaft.” Cylindrically shaped sloped sleeves 420 (420L and 420R shown in FIG. 14) are affixed to the right-hand and left-hand sides of the massaging shaft 410 so as to be inclined symmetrically with respect to its axial direction. The aforementioned arm supporters 404 (or 404R and 404L), made of a resin material, have base parts 406 (or 406R1, 406R2, 406L1 and 406L2 (only some of which are shown in the figures)) which are rotatably engaged with the outer circumferences of these sleeves 420R and 420L through rotatable bearings (not shown). Link receivers 407 (407R1, 407R2, 407L1 and 407L2 of which only some are shown in the figures) with spherical surface portions are provided between the aforementioned base parts 406 (406R1, 406R2, 406L1 and 406L2). Spherically shaped end portions 551 (551R and 551L not shown) at one end of the links 550 (550R and 550L shown in FIGS. 9 and 11) engage the link receivers 407 (407R1, 407R2, 407L1 and 407L2 some of which are shown in FIG. 21B) and are supported so as to be movable along the spherically shaped link receivers 407.

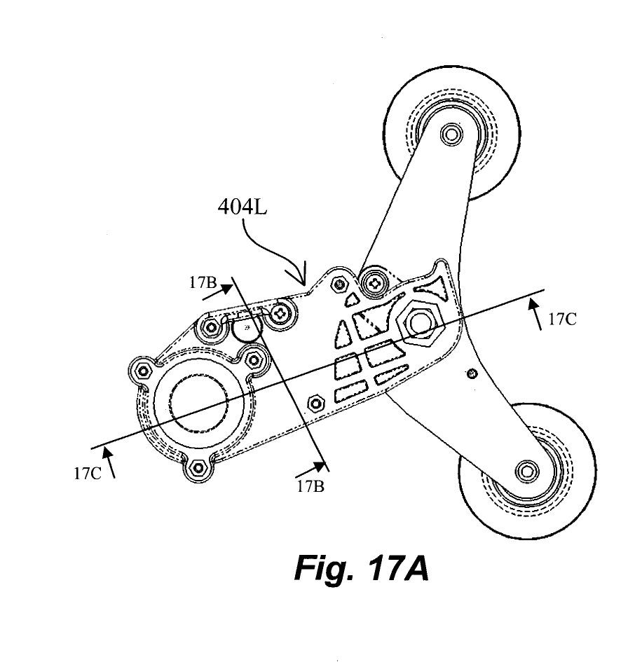

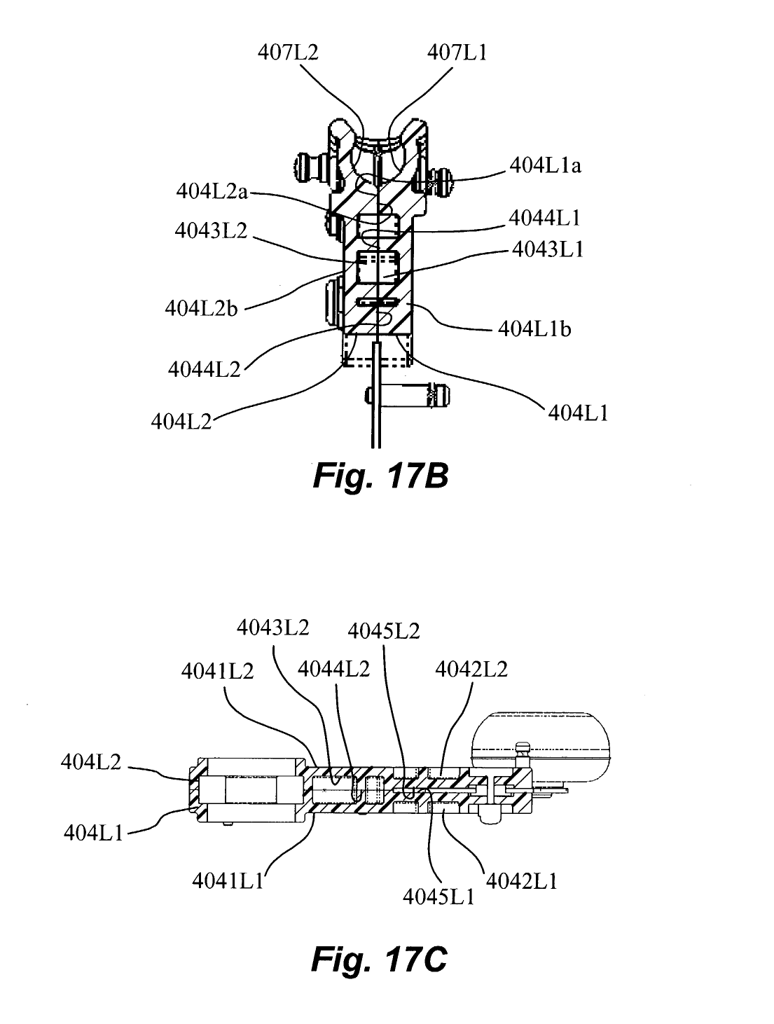

The structure of the left-hand arm supporter 404L for supporting ball supporting arm 403L is described next more in detail with reference to FIGS. 17A, 17B and 17C (together referred to as FIG. 17). The right-hand arm supporter 404R is similarly structured and will not be repetitiously explained. As explained above, the arm supporter 404L is formed with two sandwiching members 404L1 and 404L2 joined together and made of a resin material. FIG. 17A shows an outer surface of member 404L, and FIGS. 17B and 17C are its sectional views.

The portions of the inner surfaces 404L1a and 404L2a of the arm supporter 404L near its base part 406 (on the left-hand side as seen in FIG. 17B) are made uneven with protrusions and indentations such that they contact each other only through their protruding parts. Their outer side surfaces 404L1b and 404L2b are flat. The inner surface 404L2a of the sandwiching member 404L2 has contacting surface parts 4044L2 which contact the oppositely disposed sandwiching member 404L1 and a plurality of indented parts 4043L2 which are made thinner by removing some of the material. As indicated in FIGS. 17B and 17C, similar contacting surface parts 4044L1 and indented parts 4043L1 are formed on the inner surface of the other sandwiching member 404L1. The contacting surface parts 4044L1 and 4044L2 of the two sandwiching members 404L1 and 404L2 protruding towards each other contact each other and the indented parts 4043L1 and 4043L2 do not contact each other.

A flat sliding area 4045L2 is also formed on the inner surface of the sandwiching member 404L2 towards the rotary shaft 408, as shown in FIG. 17. This is an area for allowing the ball supporting arm 403L to slide on and is formed so as to be lower than that of the contacting surface part 4044L2. On the outer surface 404L1b of the other switching member 404L1, a flat part 4041L1 is formed in an area corresponding to the aforementioned indented part 4043L1 and a plurality of indented parts 4042L1 of the same height as the flat part 4041L1 are formed in an area corresponding to a slide area 4045L1.

As the pair of sandwiching members 404L1 and 404L2 thus formed is joined together to form the arm supporter 404L, their outer surfaces 404L1b and 404L2b are flat but their mutually oppositely facing inner surfaces 404L1a and 404L2a have mutually contacting protruding parts such that the structure has a higher rigidity than if they had flat contact surfaces and uneven outer surfaces. Thus, the arm supporters 404 according to the present invention are not deformed much under a load and the mutual displacement of contacting surfaces is reduced. As a result, creaking noise is less likely to be generated. Generation of such noise can be further suppressed by using different materials for the pair of sandwiching members 404R1 (and 404L1) and 404R2 (404L2).

The arm supporters 404R (404R1 and 404R2) and 404L (404L1 and 404L2) are each provided with a stopper receiver for receiving the stopper 405R or 405L. The portions of the stopper receivers where the stoppers 405R and 405L come into contact are in the same shape as that along the stoppers 405R and 405L. The stopper receivers are shaped according to the peripheral shape of the stoppers 405R and 405L as shown in FIGS. 9 and 11 such that the contact area therebetween is increased and the possibility of damage to the stoppers is diminished.

In FIGS. 13, 14 and 16, numeral 510 indicates another rotary shaft for the pounding operation, herein referred to as the “pounding shaft”, disposed above and parallel to the massaging shaft 410. On both right-hand and left-hand sides of the pounding shaft 510, at positions corresponding to those of the aforementioned sloped sleeves 420, eccentric parts 520 are formed, displaced radially in mutually opposite directions with respect to the pounding shaft 510. Bearing cases 521 (521R and 521L) are rotatably attached through bearings to the outer peripheries of the eccentric parts 520 so as to rotate over the peripheral surfaces.

As shown in FIG. 11, the pounding shaft 510 is provided with bearing cases 521 (521R and 521L) which engage the outer periphery and link receivers 522 (522R and 522L) protruding peripherally. One end of the link 550 (550R and 550L) is connected to the arm supporter 404 (404R and 404L) as shown in FIGS. 13-15, and the other end is supported so as to be movable in the axial direction of the pounding shaft 510 with respect to the link receiver 522 (522R and 522L) as shown in FIG. 11.

In summary, the pounding shaft 510 is disposed parallel to and above the massaging shaft 410 (in the left-right direction) and the rotary shafts 408 are between them in height. Thus, the spread in height becomes smaller among the massaging balls 402, the supporting arms 403, the massaging and pounding shafts 410 and 510 which drive them and the components for transmitting their driving power such as the members 404 and the links 550. As a result, the massaging machine 1 as a whole can be made compact. Although an embodiment was shown wherein the pounding shaft 510 is disposed above the massaging shaft 410, the pounding shaft 510 may be disposed below the massaging 410 with the links 510 positioned in opposite directions with respect to the members 404.

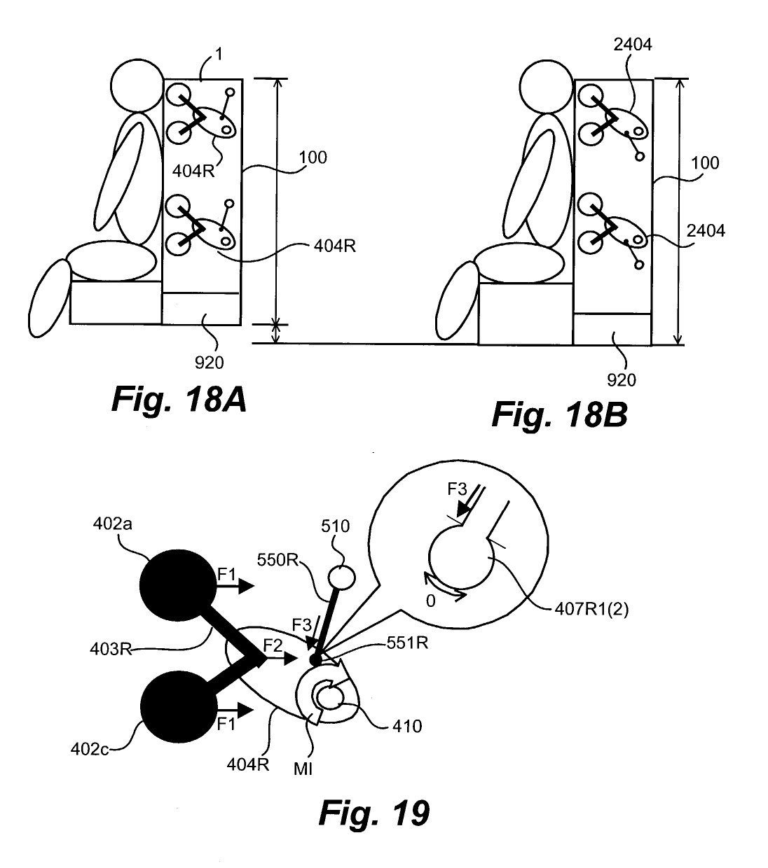

Even if the distance of travel by the massaging balls 402 along the backrest part 10a is the same, the massaging machine 1 as a whole can be made compact because the space occupied by the structure containing the massaging balls 402 becomes smaller. Although the control box 920 is shown placed next to the guide pipe 301R of the vertically mobile treatment unit 20 according to the example shown in FIGS. 1 and 4, it may be positioned below the treatment unit 20 as shown in FIG. 18 to make a more compact machine than conventional machines.

FIG. 19 shows the relationship among the forces acting on the massaging balls 402a and 402c, the supporting arm 403R, the arm supporter 404R, the massaging shaft 410 and the link 550R, (the relationship among the components on the side of the arm supporter 404L being similar). As the user sits down and his/her weight is on the backrest portion 10a, force F1 operates on the massaging balls 402a and 402c from the user's back to the back side of the massaging machine 1. As a result, force F2 operates from the supporting arm 403R to the arm supporter 404R through the rotary shaft 408R in the direction of the back side of the massaging machine 1. Thus, there results a torque M1 in the clockwise direction (with reference to the figure) around the massaging shaft 410, causing a force F to be generated from the link receivers 407R1 and 407R2 towards the spherical part 551R of the link 550R so as to push the spherical part 551R in the direction of the extension of the link 550R. Seen from the arm supporter 404R, this is a force pushing the spherical part 551R towards the spherical surface of the link receivers 407R1 and 407R2. Thus, the contact surface between the spherical part 551R and the link receivers 407R1 and 407R2 is spherical, and a large contact area means that the tears and wears become smaller.

Since a force operates from the arm supporters 404R and 404L towards the links 550R and 550L, or from the link receivers 407R1, 407L2, 407R1 and 407R2 to the extensions of the links 550R and 550L while the massaging machine 1 is being used, the spherical parts 551R and 551L are prevented from falling off from the arm supporters 404R and 404L. In other words, dedicated components for such purposes can be dispensed with and the production cost can be reduced.

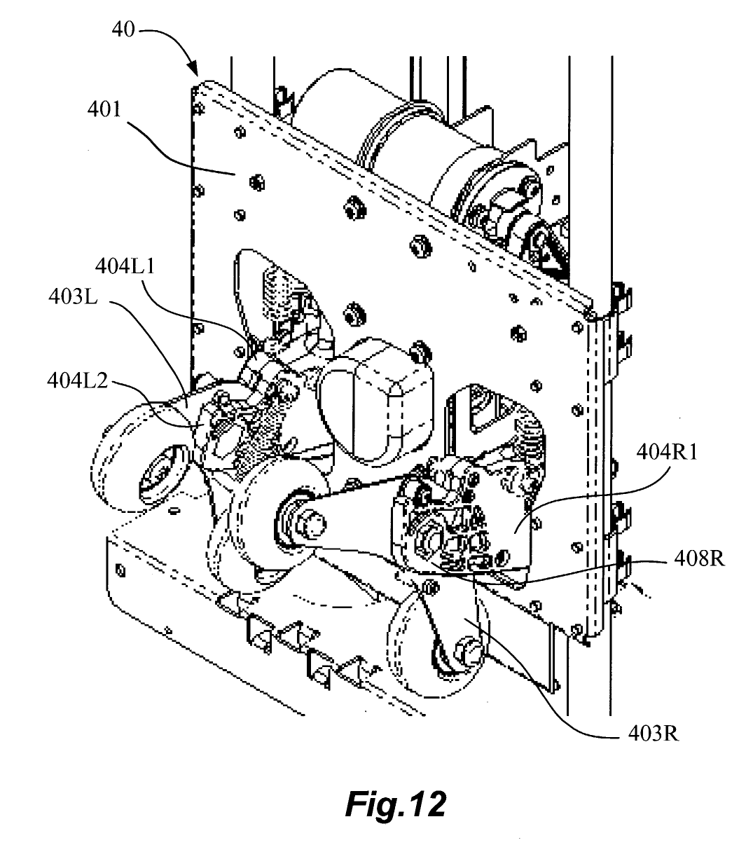

Next, the massaging mechanism of the treatment part 40 is explained. The massaging shaft 410 and the pounding shaft 510 are rotatably supported inside the ball supporting arms 403 (or 403R and 403L) by treatment shaft holders 601 (or 601R and 601L) which are affixed to a base member 401 by means of brackets 602 (or 602R and 602L) as shown in FIGS. 12-14. The treatment shaft holders 601 and the brackets 602 are hereinafter referred to as the “shaft holding means”. A motor 430 for the massaging operation (herein referred to as the “massaging motor”) is disposed perpendicularly to the base member 401 between the massaging shaft 410 and the pounding shaft 510, as shown in FIG. 16 and is detachably affixed to the treatment shaft holders 601 (or 601R and 601L) from the side opposite to the back of the user, as shown in FIG. 16.

A smaller pulley 411 is attached to the drive shaft 430a of the massaging motor 430. As shown in FIG. 16, an endless belt 413 is passed around this smaller pulley 411 and a larger pulley 412 attached to a worm gear 414. The worm gear 414 engages a worm wheel 415 which is coaxially secured over the outer periphery of the massaging shaft 410. The worm gear 414 and the worm wheel 415 are rotatably contained inside “treatment shaft holders” 601. Explained more in detail, the driving power of the massaging motor 430 is transmitted in turn through the smaller pulley 411, the belt 413, the larger pulley 412, the worm gear 414 and the worm wheel 415 to rotate the massaging shaft 410.

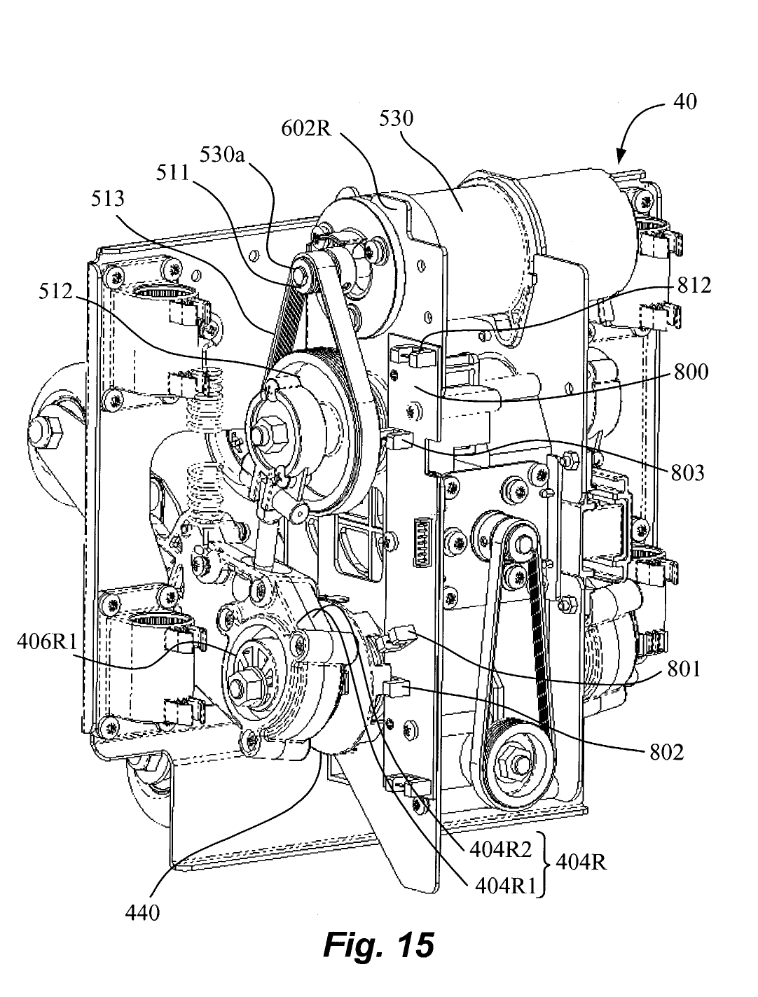

Next, the pounding mechanism of the treatment part 40 is explained. The pounding shaft 510 is driven by another motor 530 (the “pounding motor” shown in FIGS. 14 and 15) detachably affixed to the shaft holding means 602R from the side opposite to the user's back and displaced to the right-hand side, as shown in FIG. 15. A smaller pulley 511 is attached to the drive shaft of the pounding motor 530 and an endless belt 513 is passed over this smaller pulley 511 as well as a larger pulley 512 affixed coaxially to the outer periphery of the pounding shaft 510. Thus, the driving power of the pounding motor 530 is transmitted in turn through the smaller pulley 511, the belt 510 and the larger pulley 512, while being decelerated, and serves to rotate the pounding shaft 510.

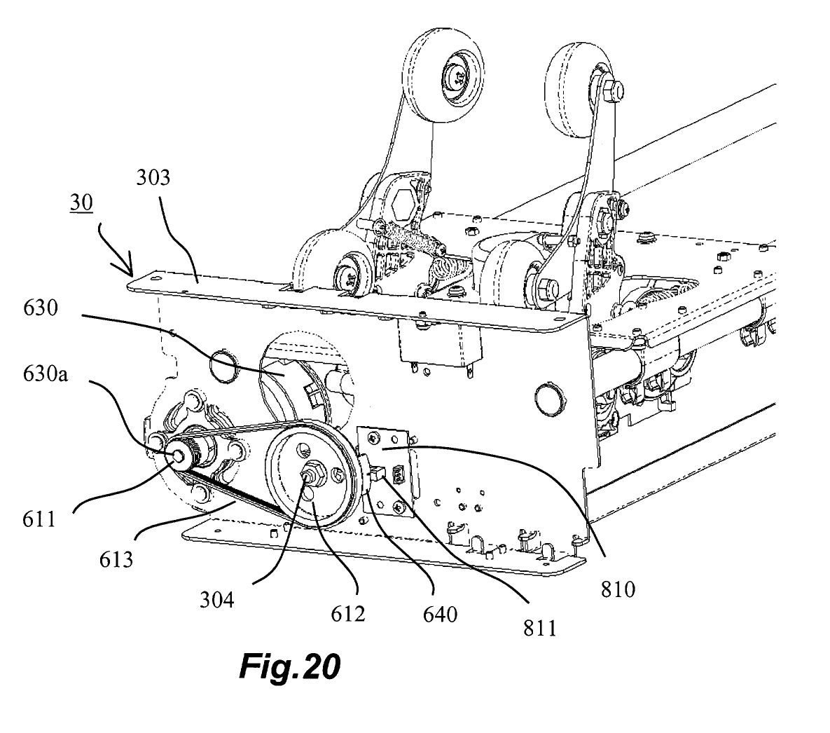

Next, the mechanism for moving the mobile treatment unit (the “lifting mechanism 30”) will be explained with reference mainly to FIG. 20.

As explained above, the lifting mechanism 30 includes a pair of guide pipes 301R and 301L (serving as guiding means) which are circular in cross-section and disposed along the backrest portion 10a, a screw shaft 304 disposed between and parallel to the two guide pipes 301R and 301L, and a pair of upper and lower guide pipe holders 302 and 303 which extend perpendicularly to the guide pipes 301R and 301L. As shown in FIGS. 5 and 13, lifting guides 306a, 306b, 306c and 306d are provided such that the treatment part 40 can slide axially along the guide pipes 301R and 301L and a nut 305 (the “lifting nut”) is provided to engage the outer periphery of the screw shaft 304.

The lifting nut 305 is supported by the aforementioned nut holder 701 which is affixed to the base member 401. The lifting guides 306a, 306b, 306c and 306d are also affixed to the base member 401.

The screw shaft 304 is driven by a motor (the “lifting motor”) 630 affixed to the lower guide pipe holder, as shown in FIG. 20. A smaller pulley 611 is attached to the drive shaft 630a of the lifting motor 630 and an endless belt 613 is passed around this smaller pulley 611 and the outer periphery of a larger pulley 612 such that the rotary power of the lifting motor 630 is transmitted in turn through the smaller pulley 611, the belt 613, the larger pulley 612 and the screw shaft 304 while being decelerated. As the screw shaft 304 is thus rotated, the nut 305 moves up or down.

Operations of the massaging machine 1 are explained next with reference to FIGS. 21 and 22 in terms of commands outputted from a CPU control circuit 900 on the basis of instructions from the input device 910 and data from the sensors to a motor control circuit 901 to drive the motors and to display data on the input device 910.

As the power switch is switched on through the input device 910 (Step S1), an LED indicative of the condition of the power switch is lit to indicate that the power switch has been switched on (Step S2). Next, the lifting motor 630 and the massaging motor 430 are moved to their initial positions (Step S3). It continues to be monitored whether they have been moved to their initial positions (Step S4) until it is determined that they have reached their initial positions. When it is ascertained that they have reached their initial positions (YES in Step S4), their motion is stopped (Step S5).

Next, it is determined whether the manual mode or the automatic mode of operation has been selected (Step S6). If the manual mode is selected, it is determined which of the manual operations has been selected (Step S7) and the selected operation is carried out (Step S8). Operations that can be selected may include “massaging upward”, “massaging downward”, “pounding”, “back stretching”, “partial back stretching”, “up” and “down”. After the selected operation has been continued for 15 minutes (Step S9), the selected operation is stopped (Step S10) and the power switch is switch off (Step S11). The LED is accordingly switched off.

If the automatic mode is selected, it is determined which of the available automatic courses has been selected (Step S12). If the “upper body course” (an appropriate combination of back stretching, massaging and pounding operations over the entire upper body from the neck downwards by the shoulders and the back to the waist) is selected, for example, operations according to a corresponding menu are carried out (Step S13) and the control proceeds to Step S11 after the menu has been finished (Step S14). If the “neck and shoulder course” (an appropriate combination of back stretch, massaging and pounding operations over the parts from the neck to the shoulders) is selected, operations according to a menu corresponding to the course are carried out (Step S15) and the control proceeds to Step S11 after the menu has been finished (Step S16). If the “waist course” (an appropriate combination of back stretching, massaging and pounding operations near the waist) is selected, operations for the corresponding menu is carried out (Step S17) and the control proceeds to Step S11 after the menu has been finished (Step S18).

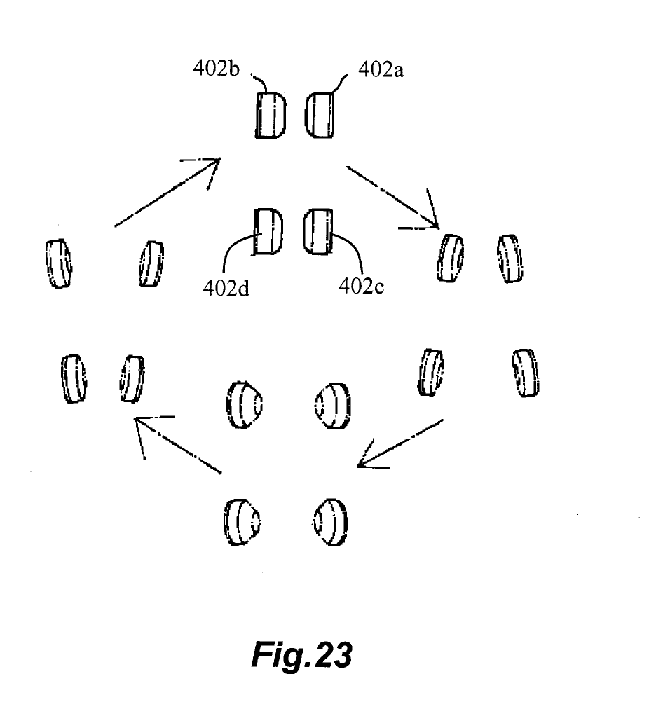

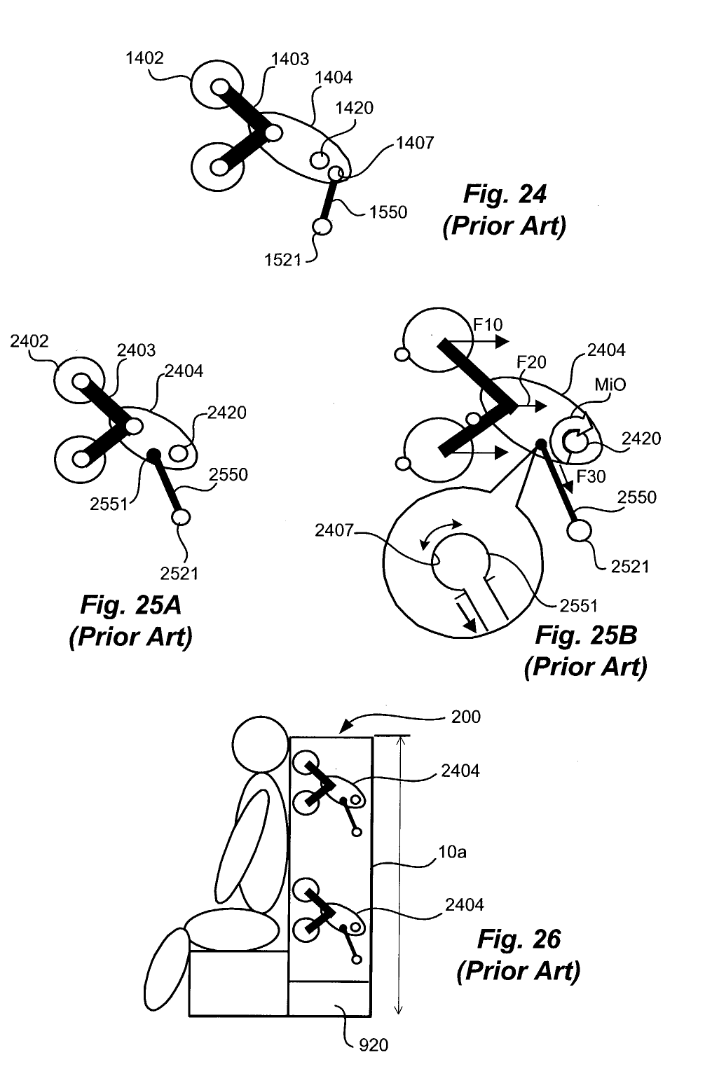

For the massaging operations, the rotary motion of the pounding shaft 510 is stopped and only the massaging shaft 410 is rotated. Since the ball supporting arms 403 (or 403R and 403L) are supported rotatably around the outer peripheries of the sloped sleeves 420 (or 420R and 420L) attached obliquely with respect to the massaging shaft 410 and the rotation around the massaging shaft 410 is limited through the links, the massaging balls 402a-d swing back and forth in the axial direction of the massaging shaft 410 while varying their distances from the axis of rotation of the massaging shaft 410, as shown in FIG. 23. The body of the user is thus massaged since the distance between massaging balls 402a-d on the right-hand and left-hand sides changes.

By changing the direction of rotation of the massaging motor 430, the direction of rotary motion of the massaging balls 403a-d can also be changed. In other words, the user can choose between “massaging upward” and “massaging downward”.

For effecting the pounding operation, the rotary motion of the massaging shaft 410 is stopped and only the pounding shaft 510 is caused to rotate. Since the links 550R and 550L are rotatably supported by the eccentric parts 520 adapted to eccentrically rotate as the pounding shaft 510 is rotated, the distance between the axis of rotation of the pounding shaft 510 and the link receivers 407R and 407L engaged to ends of the links changes as the pounding shaft 510 is rotated. Since the ball supporting arms 403R and 403L are rotatably supported around the massaging shaft 410, they swing back and forth around the massaging shaft 410 as the pounding shaft 510 is rotated at an appropriate speed.

For the back stretch operation, both the massaging and pounding shafts 410 and 510 are stopped and the ball supporting arms 403R and 403L are maintained at the position of the origin while the lifting motor 630 is activated to cause the entirety of the massaging machine 1 to move up and down along the guide pipes 301R and 301L.

As can be understood from the descriptions given above, the present invention can provide a compact massaging machine.

What is claimed is:

1. A massaging machine comprising:
massaging balls;
ball supporting arms for supporting said massaging balls;
at least two rotary shafts including a first shaft and a second shaft that have mutually parallel axes of rotation at different heights;
an eccentric part on said first shaft that is eccentric with respect to the axis of rotation of said first shaft;
a sloped part on said second shaft that is sloped with respect to the axis of rotation of said second shaft;
a support arm with one end part attached to said ball supporting arm and the other end part attached to said sloped part, said support arm having a bearing with a spherical surface; and
a link that connects said eccentric part with said support arm, said link having a spherically shaped end part that engages with said bearing with said spherical surface;
wherein said ball supporting arms are attached to said support arm at a height between the heights of said first shaft and said second shaft.

2. The massaging machine of claim 1 wherein said bearing on said support arm is at a height between the heights at which said ball supporting arm and said sloped part are attached to said support arm.
